(19) United States
(12) Patent Application Publication
(10) Pub. No.: US 2025/0335816 A1
(43) Pub. Date: Oct. 30, 2025

(54) BENCHMARK CREATOR - AN ARTIFICIAL INTELLIGENCE-BASED APPROACH TO EVALUATING THE KNOWLEDGE OF A LANGUAGE MODEL FOR A DATASET

(71) Applicant: INTUIT INC., Mountain View, CA (US)

(72) Inventors: Linoy COHEN, Ramat Gan (IL); Nitzan Gado SAGINHOR, Ness ziona (IL); Matan VETZLER, Ramat Gan (IL); Kfir AHARON, Ness-Ziona (IL)

(21) Appl. No.: 18/650,651

(22) Filed: Apr. 30, 2024

(51) Int. Cl. G06N 20/00; G06F 11/34

(52) U.S. Cl. CPC G06N 20/00; G06F 11/3428

(57) ABSTRACT

Aspects of the present disclosure relate to automated evaluation of a language processing machine learning model. Embodiments include creating, using a validated language processing machine learning model, benchmark data comprising benchmark questions based on a dataset; comparing the benchmark questions to training questions in a training data set used to train a target language processing machine learning model; removing one or more of the benchmark questions from the benchmark data based on the comparing in order to generate decontaminated benchmark data; confirming that the decontaminated benchmark data corresponds to a threshold proportion of information within the dataset; testing the decontaminated benchmark data to determine whether a question-testing machine learning model can provide correct answers to input benchmark questions from the decontaminated benchmark data without being provided with the dataset as an input; measuring a level of performance of the target language processing machine learning model using the benchmark data.

### INTRODUCTION

Aspects of the present disclosure relate to techniques for evaluating the performance of language models in performing tasks involving datasets. In particular, techniques described herein involve generating benchmark data based on a dataset, ensuring that the benchmark data covers an appropriate amount of the dataset, determining that the benchmark data do not excessively overlap with training data, ensuring that questions within the benchmark data are not overly dependent on the dataset as context, and using the benchmark data to evaluate a language model that is trained on the training data.

### BACKGROUND

A growing number of people, businesses, and organizations around the world utilize language models to assist with a wide variety of tasks. For example, a user may request that a language model generate a certain type of content, and the language model may generate the content based on the request.

Language models are generally trained using large corpuses of information that enable the models to generate content based on the information. In some instances, it may be beneficial to train or fine-tune a language model using a corpus of information that is tailored to a specific domain so that the language model will be capable of generating content related to that domain. For example, if a language model is used to answer questions related to a particular field, the language model may be trained using data that is associated with the particular field. However, ensuring that a language model has been adequately trained for generating content can be a tedious and unreliable process. As an example, evaluating the performance of a language model may involve manual verification of the model's outputs, such as by receiving feedback from users. Existing techniques for automated evaluation of language models may fail for various reasons, such as because data sets used for such automated evaluation are not sufficiently representative of the domain(s) for which a language model has been trained, are not sufficiently distinct from the training data used to train a language model, and/or are too reliant on context.

Thus, there is a need in the art for improved techniques for evaluating the performance of language models in performing tasks involving datasets.

### BRIEF SUMMARY

Certain embodiments provide a method of automated evaluation of a language model. The method generally includes: creating, using a validated language processing machine learning model, benchmark data comprising benchmark questions based on a dataset; comparing the benchmark questions to training questions in a training data set used to train a target language processing machine learning model; removing one or more of the benchmark questions from the benchmark data based on the comparing in order to generate decontaminated benchmark data; confirming that the decontaminated benchmark data corresponds to a threshold proportion of information within the dataset; testing the decontaminated benchmark data to determine whether a question-testing machine learning model can provide correct answers to input benchmark questions from the decontaminated benchmark data without being provided with the dataset as an input; and measuring a level of performance of the target language processing machine learning model using the benchmark data.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated evaluation of a language model.

FIG. 2 depicts an additional example of computing components related to automated evaluation of a language model.

FIG. 3 depicts example operations related to automated evaluation of a language model.

FIG. 4 depicts an example of a processing system for automated evaluation of a language model.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated evaluation of a language model.

According to certain embodiments, benchmark data is automatically generated based on a dataset in order to evaluate the performance of a language model, which may have been trained based on training data generated from the dataset. The benchmark data may be generated by a language model that has been trained and/or fine-tuned to perform tasks related to a domain associated with the dataset. The benchmark data may be evaluated to ensure that questions within the data cover an appropriate proportion of the dataset and are not overly specific with regards to the dataset. Also, the benchmark data may be further evaluated to determine that the benchmark data does not excessively overlap with the training data that was used to train the language model that is to be evaluated (e.g., the target language model). For example, the target language model may have been trained using a training data set that was also generated (e.g., using the same or a different language model than that used to generate the benchmark data) based on the dataset. The target language model may then be evaluated using the benchmark data.

In some embodiments, a validated language model is used to generate benchmark data based on a dataset (in some embodiments, the validated language model is also used to generate training data based on the dataset). The validated language model may be a language processing machine learning model (e.g., a large language model, or LLM) that has been trained to perform tasks (e.g., generate questions and answers to the questions) related to a particular domain and validated as effective in performing the tasks. The particular domain may be a domain related to the dataset. For example, the domain may be income tax filing, and the dataset may comprise tax filing instructions. The validated language model may be validated based on evaluating the ability of the language model to “understand” the domain and perform tasks related to the domain. For example, validation may comprise manually verifying the outputs of the language model based on manually provided inputs and/or performing an automated validation process based on validation data. In some embodiments, the validated language model is trained on a more generalized training data set, such as across multiple domains.

Some embodiments provide that the validated language model is a model that requires more resources (or is otherwise more costly to operate) than a target language model that is to be trained and benchmarked using the training and benchmark data. For example, the validated language model may have a higher number of parameters than the target language model. Having a higher number of parameters may make the validated language model more effective at performing tasks, but the higher number of parameters may also require more computational resources. By using the more costly model to generate benchmark data that can then be used to validate less costly models (and, in some embodiments, to also generate training data that is used to train such less costly models), teachings of the present disclosure allow for using the less costly model to perform tasks that may otherwise only be accomplished by the more costly model. Thus, techniques disclosed herein allow for large scale improvements to computational efficiency (e.g., the less costly models, once trained, may be used instead of the more costly models).

Certain embodiments provide that the training data comprises training questions and the benchmark data comprises benchmark questions. The benchmark questions and training questions may comprise questions related to the dataset. For example, the questions may address different topics within the dataset such as topics that are relevant to users whose questions may be submitted to a language model system. A language model that is trained with the training data may be capable of responding to similar questions from users, such as questions related to the domain associated with the dataset. Evaluating the performance of a language model in answering the benchmark questions may provide an indication of the language model's effectiveness in answering questions related to the domain associated with the dataset. The training data and benchmark data may further comprise answers to the questions.

In some embodiments, the benchmark questions and/or the training questions may comprise multiple choice questions. Performing training and/or benchmarking using multiple choice questions may save time and computational resources compared to training and benchmarking procedures that involve generating other types of outputs, such as natural language answers to questions. The answers to the multiple choice questions may include a correct answer and one or more incorrect answers. The validated machine learning model may be instructed to generate the questions in such a way that the questions cover various topics of the dataset in a way that is not overly dependent upon the dataset (e.g., a question may be overly dependent on the dataset if the question asks for a specific date that is found within an illustrative hypothetical example found inside the dataset). Training and/or evaluating a language model using multiple-choice questions may save time and computing resources compared to using short answer or other open-ended questions for training and evaluation. For example, evaluating the correctness of a close-ended multiple choice question may involve determining whether the correct answer choice was selected. By contrast, evaluating open-ended questions may involve determining the semantic meaning of each answer and comparing the meaning to the meaning of a correct answer.

According to some embodiments, the benchmark data (and, in some embodiments, the training data) may be provided to a component that determines whether the questions within the data correspond to a threshold proportion of information within the dataset. For example, the component may comprise a language model such as an LLM-as-a-judge model that is trained to evaluate questions based on their coverage of a dataset. If a set of questions, such as the training questions or the benchmark questions, fails to include a question related to a particular topic found within the dataset, it may be determined that the set of questions needs to be replaced and/or augmented, and the validated machine learning model may replace and/or augment the set of questions (such as by generating a new and/or augmented set of benchmark questions and/or training questions). Ensuring that the benchmark questions and/or training questions contain questions that correspond to all relevant topics of the dataset increases the likelihood that a target machine learning model trained and/or validated with the questions will be effective in answering questions related to the dataset.

Some embodiments provide that the benchmark data and training data may be provided to a component that determines whether the sets of questions (and/or answers) overlap by more than a threshold amount. If questions within the benchmark question set overlap to a sufficient extent with questions from the training question set, the results of running a benchmark test may be skewed. For example, when a training question is too similar to a benchmark question (e.g., the questions are identical or otherwise very similar), a language model that is trained using the training question may be able to correctly answer the benchmark question even if the language model is not effective at answering questions related to a domain associated with the dataset. Thus, the benchmark test may indicate that the language model performs at a high level even though the language model is not effective at answering questions from users related to the domain. By contrast, when the overlap between benchmark questions and training questions is minimized, a language model performing well with the benchmark questions may indicate that the language model is effective at answering questions related to the domain (e.g., the model “understands” the concepts contained within the dataset and is not just remembering the answer to a question from the training data). One or more of the benchmark questions may be removed from the benchmark data based on a determination that the benchmark questions overlap with the training questions by more than a threshold amount, resulting in a decontaminated set of benchmark data.

Checking the data for excessive similarity may involve textual similarity evaluations. For example, n-gram representations of the benchmark questions and the training questions may be created (n-grams are generally groups of up to n consecutive words or characters, where n is a positive integer). The n-gram representations may be compared, and if a question of the set of benchmark questions is more than a threshold amount similar to a question of the set of training questions (or if one set is more than a threshold amount similar to the other), one or more of the questions may be removed and/or replaced, such as with a newly generated question. Other textual similarity comparison techniques may be used as well.

Checking the data for excessive similarity may involve semantic similarity evaluations. For example, embedding representations of the benchmark questions and the training questions may be created. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. The embedding representations may be compared, and if a question of the set of benchmark questions is more than a threshold amount similar to a question of the set of training questions (or if one set is more than a threshold amount similar to the other), one or more of the questions may be removed and/or replaced, such as with a newly generated question. Other semantic similarity comparison techniques may be used as well.

In some embodiments, the benchmark questions and/or training questions may be tested to determine whether a language model that has been validated as performing at a high level performs well on the benchmark questions and/or training questions without relying on the dataset. For example, a question-testing language model used to test the questions may be a language model that has been validated as high-performing, such as by manually or otherwise verifying the correctness of answers output by the model. The question-testing language model may be trained using the dataset or information related to a domain associated with the dataset.

Certain embodiments provide that the question-testing language model may be provided with the questions from the benchmark data (and/or the training data) and asked to answer the questions. Then the question-testing language model may be provided with the dataset used to generate the questions and asked to answer the questions again. Both sets of answers may be scored based on correctness. If the score for the set of answers that was output when the question-testing model was provided with the dataset is more than a threshold amount higher than the score of the answers output when the model was not provided with the dataset, this may indicate that the questions are overly specific with respect to the dataset (e.g., a question may relate to an irrelevant detail instead of an important concept or topic). For example, a question may ask for specific details regarding an illustrative hypothetical situation contained within the dataset. Such a question would not be relevant to training a language model to answer a question from a user, and may result in an erroneous determination that a language model is not effective at answering questions if used in the benchmark data. Thus, if a question (or a set of questions) is determined to be too specific to the particular dataset, the question (or questions) may be replaced such as with new questions generated by the validated language model.

According to some embodiments, the training data may be used to train the target machine learning model. For example, the target model may be trained through a supervised learning process using the answer choices for the training questions as labeling data. The correct answers may be labeled as ground truth examples and the incorrect answers may be labeled as negative examples.

Certain embodiments provide that the level of performance of the trained target language model may be measured using the benchmark data. For example, the trained target model may answer the benchmark questions and then may be assigned a score based on the percentage of the questions the model answered correctly (e.g., based on comparing the output answers to the answers in the benchmark data, such as based on syntactic and/or semantic similarity). If the model answers more than a threshold percentage correct, this may indicate that the model is effective at answering questions related to the domain associated with the dataset. One or more actions may be taken based on this indication, such as providing an indication to a user that the model is effective, selecting the model for use in a task, and/or comparing the performance of the model to other models that have been tested using the benchmark data. Additionally, a level of consistency for the model may be determined by prompting the model to answer the benchmark questions multiple times. For example, if the sets of answers output by the model exhibit a large amount of variance, it may be determined that the model is inconsistent.

In some embodiments, if a determination is made that the target language model is ineffective or inconsistent, the target language model may be retrained. Retraining the target language model may comprise generating new training data and/or benchmark data for the target language model and/or re-training and/or re-evaluating the model based on new and/or existing training and/or benchmark data.

Embodiments of the present disclosure provide numerous technical and practical effects and benefits. For instance, manual assessment of the performance of a language model can require an extensive amount of trial and error, resulting in wasted time, labor, and computing resources. The automated performance assessment described herein can greatly reduce and even eliminate this waste. Additionally, teachings of the present disclosure overcome deficiencies in existing automated language model assessment techniques. For example, the teachings discussed herein help ensure that a target language model will be trained and/or validated on all relevant portions of a dataset, thereby providing improved results as compared to existing automated language model assessment techniques. Also, by eliminating overlap between training data and benchmark data, erroneous determinations that a language model is effective that would otherwise occur with existing automated language model assessment techniques may be reduced. Furthermore, by ensuring that benchmark data is not overly reliant on and/or specific to the dataset from which the benchmark data was generated, techniques described herein avoid the use of benchmark questions that are not effective for evaluating the performance of a language model but that would otherwise be used in existing language model assessment techniques.

### Example Components Related to Automated Evaluation of a Language Processing Machine Learning Model

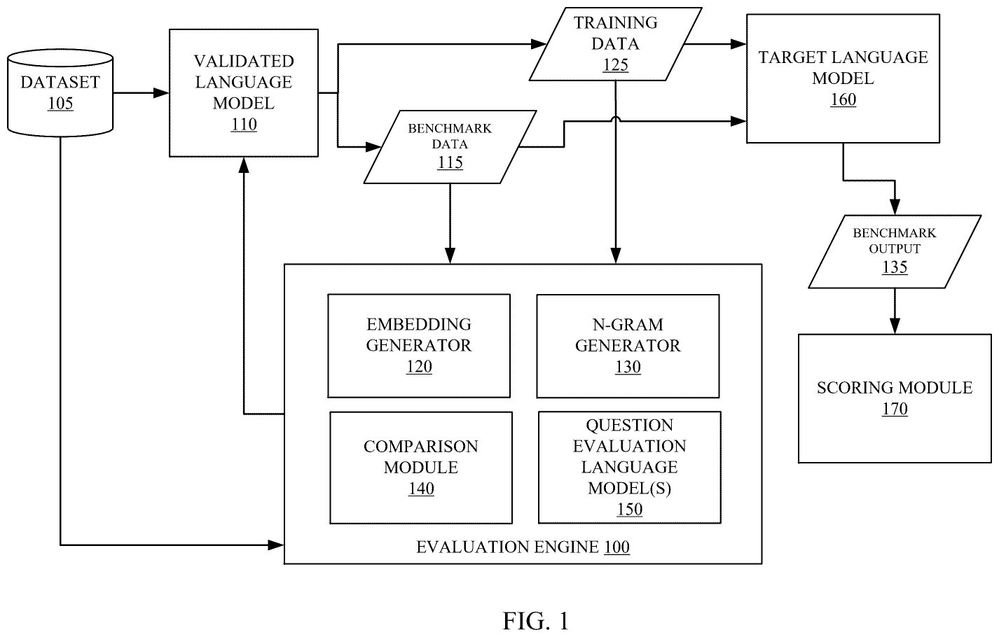

FIG. 1 is an illustration of example computing components related to automated evaluation of a language model.

A dataset 105 may be provided to a validated language processing machine learning model 110. The dataset may be a dataset associated with a domain for which user may ask questions that are to be answered by a target language model. For example, the domain may be income tax filing, the dataset 105 may comprise tax filing instructions, and users may ask questions related to income tax filing. Thus, the goal of training a target language model 160 in this example may be to allow the target language model 160 to answer questions related to income tax filing.

The validated language model 110 may comprise a language model such as a large language model. The validated language model 110 may be validated by verifying outputs of the model after it has been trained to ensure that it has been effectively trained. The validated language model 110 may be a different type of language model than the target language model 160, such as a model with a higher number of parameters, that otherwise uses larger amounts of computing resources, and/or that is associated with other costs and/or limitations than the target language model 160. The validated language model 110 may be trained to generate benchmark data 115 comprising benchmark questions (and, in some embodiments training data 125 comprising training questions). The questions may be multiple choice questions with one correct answer and at least one incorrect answer.

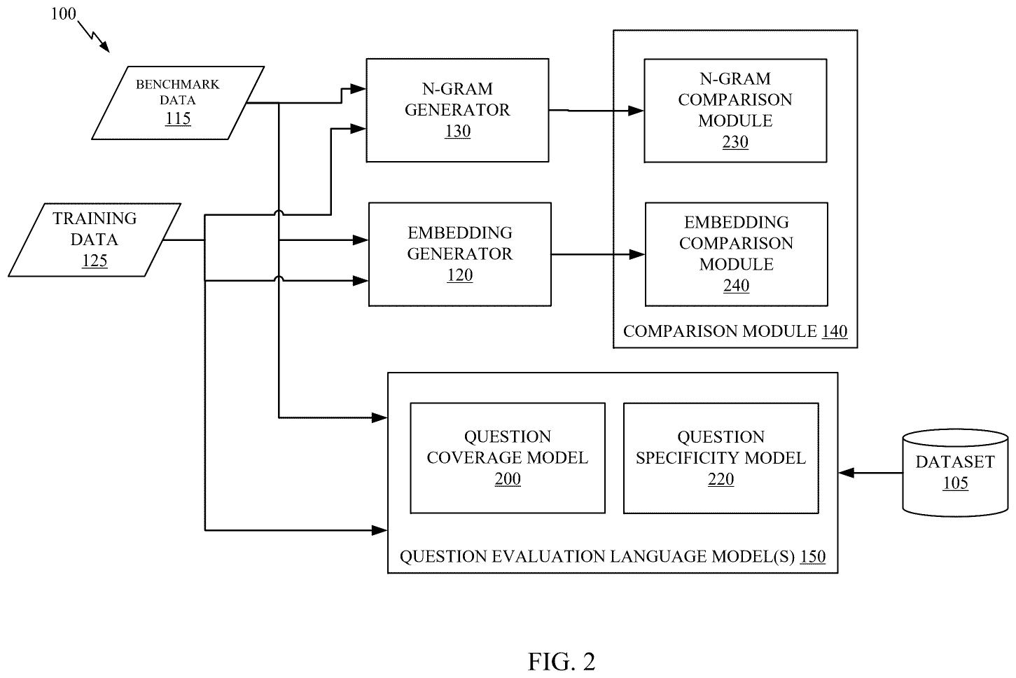

The training data 125, benchmark data 115, and/or the dataset 105 may be provided to an evaluation engine 100, discussed in further detail below with respect to FIG. 2. The evaluation engine 100 may ensure that the questions sufficiently cover a threshold amount of topics within the dataset 105, such as by using a question evaluation language model 150 to determine that a sufficient number of the questions correspond to particular topics within the dataset 105. Also, the evaluation engine 100 may ensure that the benchmark questions and the training questions do not overlap by more than a threshold amount. Detecting overlap between questions may comprise performing a textual similarity comparison such as by using n-gram generator 130 to create n-gram representations of questions and using comparison module 140 to compare the n-gram representations. Detecting overlap between questions may comprise performing a semantic similarity comparison such as by using embedding generator 120 to create embedding representations of questions and using comparison module 140 to compare the embedding representations, such as based on cosine similarity. Additionally, the evaluation engine 100 may ensure that the questions are not overly specific with respect to the dataset 105, such as by using a question evaluation language model 150 to answer the questions with and without the dataset 105. If the evaluation engine 100 discovers that a question or a set of questions contains an issue (e.g., the questions are overly specific, overlap too much with training data, and/or do not cover enough topics contained within the dataset 105), the evaluation engine 100 may prompt the validated language model 110 to generate additional questions and/or replacement questions. For example, the evaluation engine 100 may provide the validated language model 110 with an indication of the issue that was discovered and instruct the validated language model 110 to generate one or more replacement questions. The replacement questions may be used to replace questions in the benchmark data 115 and/or the training data 125. After the evaluation engine 100 determines that the benchmark data 115 does not contain issues, the benchmark data 115 may be used to measure the effectiveness of the target language model 160. In some embodiments, training data 125 is first evaluated and, if the evaluation engine 100 determines that the training data 125 does not contain issues, then the training data 125 is used to train the target language model 160.

The target language model 160 may be a language processing machine learning model such as an LLM. The goal of training the target language model 160 with the training data 125 may be to allow the target language model 160 to answer questions based on the domain and/or the dataset 105. The target language model 160 may be trained to answer questions through a supervised learning process. Supervised learning techniques generally involve providing training inputs to a machine learning model. The machine learning model processes the training inputs and outputs predictions based on the training inputs. The predictions are compared to the known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art. For example, the supervised learning process used to train the target language model 160 may involve using the answer choices for the training questions as labeling data. The correct answers may be labeled as ground truth examples and the incorrect answers may be labeled as negative examples.

After the target language model 160 is trained using the training data 125, the target language model may be provided with the benchmark data 115 as input. The target language model 160 may generate a benchmark output 135 comprising answers to the questions within the benchmark data 115 (such as by selecting an answer of the answer choices within benchmark data 115). Scoring module 170 may compare the answers selected by target language model 160 to the known correct answers of benchmark data 115, and assign a score to the benchmark output 135 based on the comparison. For example, the score may be a percentage of answers that were correct. If the score fails to exceed a threshold, one or more actions may be taken, such as retraining the target language model 160, providing an indication to a user that the target language model 160 has a low level of performance, and/or generating new training data 125 and/or benchmark data 125. If the score exceeds the threshold, one or more other actions may be taken, such as selecting the target language model 160 for use and/or providing an indication to a user that the target language model 160 has a high level of performance. The score for the target language model 160 may be compared to scores for other language models, and/or the benchmark output generation and scoring process may be repeated multiple times for the target language model 160 to determine the consistency of the target language model 160, and one or more actions such as those described above may be taken in response to the determined consistency. For example, if the target language model 160 is determined to be inconsistent, it may be retrained.

FIG. 2 is an illustration of additional example computing components related to automated evaluation of a language processing machine learning model. Specifically, FIG. 2 illustrates example computing components associated with evaluation engine 100 of FIG. 1.

Benchmark data 115 and training data 125 may be provided to n-gram generator 130. N-gram generator 130 may comprise a component that runs on one or more processors and that is configured to create n-gram representations (i.e., groupings of up to n consecutive words and/or characters, where n is a positive integer) of the benchmark data 115 and training data 125. The n-gram representations of the benchmark data 115 and training data 125 may be provided to comparison module 140, where n-gram comparison module 230 may compare the n-grams to determine whether questions within the benchmark data 115 overlap with questions within the training data 125 by more than a threshold amount. If it is determined that the training questions overlap with the benchmark questions by more than the threshold amount, one or more of the training and/or benchmark questions may be removed, and one or more new benchmark and/or training questions may be generated. For example, if a benchmark question and a training question overlap by more than the threshold, the benchmark question may be removed from the benchmark data 115 and replaced with another benchmark question, while the training question may not be removed from the training data 125. As a result of removing overlapping questions, the benchmark data 115 may be “decontaminated,” meaning that it does not contain overlapping questions that could cause an erroneous determination that a language model has a high level of performance.

Benchmark data 115 and training data 125 may be provided to embedding generator 120. Embedding generator 120 may comprise an embedding model, such as a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating embeddings are possible.

The embedding generator 120 may create embedding representations (i.e., vector representations of an entity that represent the entity as a vector in n-dimensional space such that similar entities are represented by vectors that are close to one another in the n-dimensional space) of the benchmark data 115 and training data 125. The embedding representations of the benchmark data 115 and training data 125 may be provided to comparison module 140, where embedding comparison module 240 may compare the embedding representations to determine whether questions within the benchmark data 115 semantically overlap with questions within the training data 125 by more than a threshold amount. As discussed above with respect to the n-gram-based data comparison, one or more questions may be removed from the training data 125 and/or benchmark data 115, and these questions may be replaced with newly generated questions, resulting in a decontaminated set of benchmark data 115 and/or training data 125.

Benchmark data 115 and/or training data 125 may be provided to one or more question evaluation language models 150. One of the evaluation language models 150 may be a question coverage model 200. The question coverage model 200 may comprise a language model such as an LLM. The question coverage model 200 may evaluate questions within the benchmark data 115 (and, in some embodiments, training data 125) to determine whether the questions within a given set of data correspond to a threshold proportion of information within the dataset 105 and/or whether each topic is covered by a threshold number of questions (e.g., the threshold for a given topic may be determined based on the importance/relevance of the given topic). For example, the question coverage model 200 may be provided with the dataset 105 and extract topics from the dataset 105. The question coverage model 200 may then evaluate the benchmark data 115 (and, in some embodiments, the training data 125) to determine the extent to which such data contains questions that relate to each topic. The question coverage model 200 may evaluate the importance of each topic (e.g., based on the proportion of the dataset 105 that relates to that topic), and a threshold number of questions may be determined for the topic; if this threshold is not met, it may be determined that the topic is not sufficiently covered. For example, if a set of questions contains multiple questions that relate to a topic, the question coverage model 200 may determine that this topic is well-covered. As another example, if a set of questions does not contain any questions that relate to a topic, the question coverage model 200 may determine that this topic is not well-covered. For important topics, if a set of questions only contains a few questions related to the topic, it may be determined that the topic is not well-covered. If a determination is made that the benchmark data 115 and/or training data 125 do not sufficiently cover a topic within the dataset, one or more actions may be taken, such as generating new questions that cover the topic. For example, if the question coverage model 200 determines that the questions within the benchmark data 115 do not sufficiently cover a topic in the dataset 105, a prompt may be provided to the validated language model 110 to generate one or more questions that are related to the topic. These new questions may be included in the benchmark data 115.

One of the evaluation language models 150 may be a question specificity model 220. The question specificity model 220 may be a language model (such as an LLM) that has been validated as high-performing, such as by manually or otherwise verifying the correctness of answers output by the model. In certain embodiments, the question specificity model 220 may have a higher number of parameters (or may otherwise be more powerful, effective, and/or costly) than a target language model 160. The question specificity model 220 may be trained using the dataset 105, information related to a domain associated with the dataset 105, and/or based on a broader data set, such as covering multiple domains. The question specificity model 220 may be provided with a set of questions, such as questions within the benchmark data 115 and/or training data 125, and asked to select a correct answer choice for the questions. Then, the question specificity model 220 may be provided with the dataset 105 as an input and asked to select correct answer choices to the questions again. The answer selections output by the question specificity model 220 may be scored based on correctness. If the score for the selections made when the question specificity model 220 was provided with the dataset 105 exceeds the score for the selections made when the question specificity model 220 was not provided with the dataset 105 by more than a threshold amount, then it may be determined that the questions are overly specific with respect to the dataset (e.g., the questions may relate to irrelevant details of the dataset instead of important concepts). Based on such a determination, one or more additional questions may be generated and used to replace one or more of the original questions. For example, if the question specificity model 220 correctly answers a question within the benchmark data 115 when provided with the dataset 105, but was unable to answer the question correctly without being provided with the dataset 105, this question may be replaced in the benchmark data 115 by a newly generated question. As an example, generating the new question may involve providing the validated language model 110 with a prompt asking it to generate a question that is more focused on an important concept.

### Example Operations Related to Automated Evaluation of a Language Processing Machine Learning Model

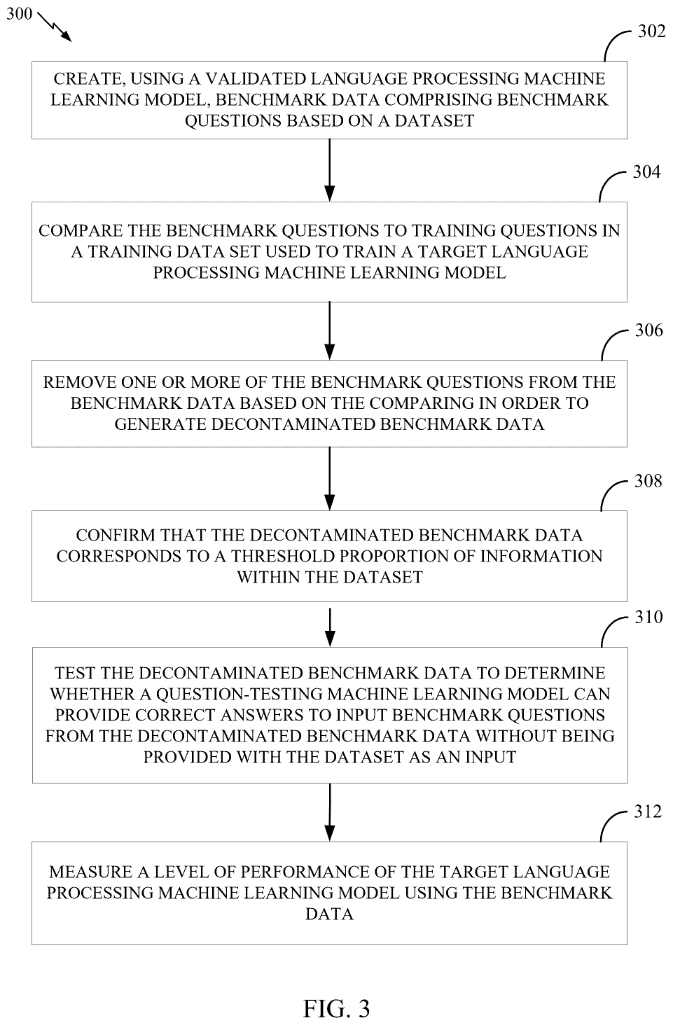

FIG. 3 depicts example operations 300 related to automated evaluation of a language processing machine learning model. For example, operations 300 may be performed by one or more of the components described in FIG. 1 and FIG. 2.

Operations 300 begin at step 302 with creating, using a validated language processing machine learning model, benchmark data comprising benchmark questions based on a dataset. Certain embodiments provide that the benchmark data further comprises multiple choice answers comprising one correct answer and at least one incorrect answer to each of the benchmark questions.

Operations 300 continue at step 304 with comparing the benchmark questions to training questions in a training data set used to train a target language processing machine learning model. In certain embodiments, the training data set further comprises multiple choice answers comprising one correct answer and at least one incorrect answer to each of the training questions. In some embodiments, comparing the benchmark questions to training questions in a training data set comprises determining a level of textual similarity between a training question of the training questions and a benchmark question of the benchmark questions. According to certain embodiments, comparing the benchmark questions to training questions in a training data set comprises determining a level of semantic similarity between a training question of the training questions and a benchmark question of the benchmark questions.

Operations 300 continue at step 306 with removing one or more of the benchmark questions from the benchmark data based on the comparing in order to generate decontaminated benchmark data.

Operations 300 continue at step 308 with confirming that the decontaminated benchmark data corresponds to a threshold proportion of information within the dataset. Some embodiments provide that confirming that the decontaminated benchmark data corresponds to the threshold proportion of information within the dataset comprises using a question-evaluating machine learning model to determine that a threshold number of topics within the dataset are represented by the decontaminated benchmark data.

Operations 300 continue at step 310 with testing the decontaminated benchmark data to determine whether a question-testing machine learning model can provide correct answers to input benchmark questions from the decontaminated benchmark data without being provided with the dataset as an input. In certain embodiments, testing the decontaminated benchmark data comprises: using the question-testing machine learning model to generate a first set of answers to the input benchmark questions from the decontaminated benchmark data, wherein the dataset is not provided as an input to the question-testing machine learning model in connection with generating the first set of answers; using the question-testing machine learning model to generate a second set of answers to the input benchmark questions from the decontaminated benchmark data, wherein the dataset is provided as an input to the question-testing machine learning model in connection with generating the second set of answers; scoring the first set of answers and the second set of answers based on correctness; and determining that the decontaminated benchmark data is suitable for evaluating language processing machine learning model performance based on the scoring.

Operations 300 continue at step 312 with measuring a level of performance of the target language processing machine learning model using the benchmark data. Some embodiments provide that the target language processing machine learning model is retrained based on the measured level of performance of the target language processing machine learning model failing to meet a performance threshold. According to certain embodiments, measuring the level of performance of the target language processing machine learning model using the decontaminated benchmark data is based on using the target language processing machine learning model to generate answers to questions in the decontaminated benchmark data and scoring the generated answers. In some embodiments, measuring the level of performance of the target language processing machine learning model comprises generating multiple sets of answers to the questions in the decontaminated benchmark data, wherein the generated multiple sets of answers are used to determine a level of consistency of the target language processing machine learning model.

In certain embodiments, multiple language processing machine learning models, including the target language processing machine learning model, are trained using the training data set, and the target language processing machine learning model is selected from the multiple language processing machine learning models for use based on the measured level of performance of the target language processing machine learning model meeting a performance threshold.

### Example of a Processing System for Automated Evaluation of a Language Processing Machine Learning Model

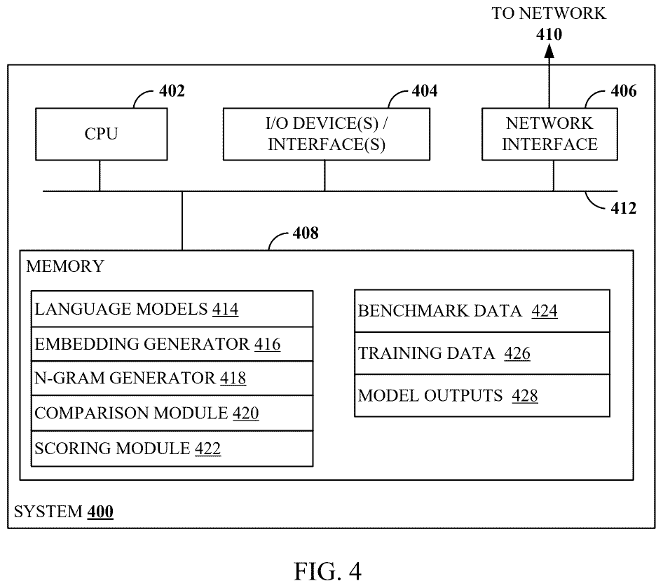

FIG. 4 illustrates an example system 400 with which embodiments of the present disclosure may be implemented. For example, system 400 may be configured to perform operations 300 of FIG. 3 and/or to implement one or more components as in FIG. 1 or FIG. 2.

System 400 includes a central processing unit (CPU) 402, one or more I/O device interfaces that may allow for the connection of various I/O devices 404 (e.g., keyboards, displays, mouse devices, pen input, etc.) to the system 400, network interface 406, a memory 408, and an interconnect 412. It is contemplated that one or more components of system 400 may be located remotely and accessed via a network 410. It is further contemplated that one or more components of system 400 may comprise physical components or virtualized components.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408. CPU 402 is included to be representative of a single CPU, multiple CPUs, a single CPU having multiple processing cores, and other arrangements.

Additionally, the memory 408 is included to be representative of a random access memory or the like. In some embodiments, memory 408 may comprise a disk drive, solid state drive, or a collection of storage devices distributed across multiple storage systems. Although shown as a single unit, the memory 408 may be a combination of fixed and/or removable storage devices, such as fixed disc drives, removable memory cards or optical storage, network attached storage (NAS), or a storage area-network (SAN).

As shown, memory 408 includes language models 414, embedding generator 416, n-gram generator 418, comparison module 420, and scoring module 422. Language models 414 may be representative of validated language model 110, target language model 160, or question evaluation language model(s) 150 of FIG. 1, which may include question coverage model 200 and/or question specificity model 220 of FIG. 2. In some embodiments, embedding generator 416 may be representative of embedding generator 120 of FIG. 1 and FIG. 2. N-gram generator 418 may be representative of n-gram generator 130 of FIG. 1 and FIG. 2. Comparison module 420 may be representative of comparison module 140 of FIG. 1 and FIG. 2, which may include n-gram comparison module 230 and/or embedding comparison module 240 of FIG. 2. Scoring module 422 may be representative of scoring module 170 of FIG. 1.

Memory 408 further comprises benchmark data 424, which may correspond to benchmark data 115 of FIG. 1 and FIG. 2. Memory 408 further comprises training data 426, which may correspond to training data 125 of FIG. 1 and FIG. 2. Memory 408 further comprises model outputs 428, which may include benchmark output 135 of FIG. 1.

It is noted that in some embodiments, system 400 may interact with one or more external components, such as via network 410, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automated evaluation of a language processing machine learning model, comprising:
creating, using a validated language processing machine learning model, benchmark data comprising benchmark questions based on a dataset;
comparing the benchmark questions to training questions in a training data set used to train a target language processing machine learning model;
removing one or more of the benchmark questions from the benchmark data based on the comparing in order to generate decontaminated benchmark data;
confirming that the decontaminated benchmark data corresponds to a threshold proportion of information within the dataset;
testing the decontaminated benchmark data to determine whether a question-testing machine learning model can provide correct answers to input benchmark questions from the decontaminated benchmark data without being provided with the dataset as an input; and
measuring a level of performance of the target language processing machine learning model using the benchmark data.

2. The method of claim 1, further comprising retraining the target language processing machine learning model based on the measured level of performance of the target language processing machine learning model failing to meet a performance threshold.

3. The method of claim 1, wherein multiple language processing machine learning models, including the target language processing machine learning model, are trained using the training data set, and wherein the target language processing machine learning model is selected from the multiple language processing machine learning models for use based on the measured level of performance of the target language processing machine learning model meeting a performance threshold.

4. The method of claim 1, wherein confirming that the decontaminated benchmark data corresponds to the threshold proportion of information within the dataset comprises using a question-evaluating machine learning model to determine that a threshold number of topics within the dataset are represented by the decontaminated benchmark data.

5. The method of claim 1, wherein comparing the benchmark questions to training questions in a training data set comprises determining a level of textual similarity between a training question of the training questions and a benchmark question of the benchmark questions.

6. The method of claim 1, wherein comparing the benchmark questions to training questions in a training data set comprises determining a level of semantic similarity between a training question of the training questions and a benchmark question of the benchmark questions.

7. The method of claim 1, wherein testing the decontaminated benchmark data comprises:
using the question-testing machine learning model to generate a first set of answers to the input benchmark questions from the decontaminated benchmark data, wherein the dataset is not provided as an input to the question-testing machine learning model in connection with generating the first set of answers;
using the question-testing machine learning model to generate a second set of answers to the input benchmark questions from the decontaminated benchmark data, wherein the dataset is provided as an input to the question-testing machine learning model in connection with generating the second set of answers;
scoring the first set of answers and the second set of answers based on correctness; and
determining that the decontaminated benchmark data is suitable for evaluating language processing machine learning model performance based on the scoring.

8. The method of claim 1, wherein the training data set further comprises multiple choice answers comprising one correct answer and at least one incorrect answer to each of the training questions, wherein the benchmark data further comprises multiple choice answers comprising one correct answer and at least one incorrect answer to each of the benchmark questions.

9. The method of claim 1, wherein measuring the level of performance of the target language processing machine learning model using the decontaminated benchmark data is based on using the target language processing machine learning model to generate answers to questions in the decontaminated benchmark data and scoring the generated answers.

10. The method of claim 9, wherein measuring the level of performance of the target language processing machine learning model comprises generating multiple sets of answers to the questions in the decontaminated benchmark data, wherein the generated multiple sets of answers are used to determine a level of consistency of the target language processing machine learning model.

11. A system for automated evaluation of a language processing machine learning model, comprising:
one or more processors; and
a memory comprising instructions that, when executed by the one or more processors, cause the system to:
create, using a validated language processing machine learning model, benchmark data comprising benchmark questions based on a dataset;
compare the benchmark questions to training questions in a training data set used to train a target language processing machine learning model;
remove one or more of the benchmark questions from the benchmark data based on the comparing in order to generate decontaminated benchmark data;
confirm that the decontaminated benchmark data corresponds to a threshold proportion of information within the dataset;
test the decontaminated benchmark data to determine whether a question-testing machine learning model can provide correct answers to input benchmark questions from the decontaminated benchmark data without being provided with the dataset as an input; and
measure a level of performance of the target language processing machine learning model using the benchmark data.

12. The system of claim 11, further comprising retraining the target language processing machine learning model based on the measured level of performance of the target language processing machine learning model failing to meet a performance threshold.

13. The system of claim 11, wherein multiple language processing machine learning models, including the target language processing machine learning model, are trained using the training data set, and wherein the target language processing machine learning model is selected from the multiple language processing machine learning models for use based on the measured level of performance of the target language processing machine learning model meeting a performance threshold.

14. The system of claim 11, wherein confirming that the decontaminated benchmark data corresponds to the threshold proportion of information within the dataset comprises using a question-evaluating machine learning model to determine that a threshold number of topics within the dataset are represented by the decontaminated benchmark data.

15. The system of claim 11, wherein comparing the benchmark questions to training questions in a training data set comprises determining a level of textual similarity between a training question of the training questions and a benchmark question of the benchmark questions.

16. The system of claim 11, wherein comparing the benchmark questions to training questions in a training data set comprises determining a level of semantic similarity between a training question of the training questions and a benchmark question of the benchmark questions.

17. The system of claim 11, wherein testing the decontaminated benchmark data comprises:
using the question-testing machine learning model to generate a first set of answers to the input benchmark questions from the decontaminated benchmark data, wherein the dataset is not provided as an input to the question-testing machine learning model in connection with generating the first set of answers;
using the question-testing machine learning model to generate a second set of answers to the input benchmark questions from the decontaminated benchmark data, wherein the dataset is provided as an input to the question-testing machine learning model in connection with generating the second set of answers;
scoring the first set of answers and the second set of answers based on correctness; and
determining that the decontaminated benchmark data is suitable for evaluating language processing machine learning model performance based on the scoring.

18. The system of claim 11, wherein the training data set further comprises multiple choice answers comprising one correct answer and at least one incorrect answer to each of the training questions, wherein the benchmark data further comprises multiple choice answers comprising one correct answer and at least one incorrect answer to each of the benchmark questions.

19. The system of claim 11, wherein measuring the level of performance of the target language processing machine learning model using the decontaminated benchmark data is based on using the target language processing machine learning model to generate answers to questions in the decontaminated benchmark data and scoring the generated answers.

20. The system of claim 19, wherein measuring the level of performance of the target language processing machine learning model comprises generating multiple sets of answers to the questions in the decontaminated benchmark data, wherein the generated multiple sets of answers are used to determine a level of consistency of the target language processing machine learning model.
